(19) United States
(12) Patent Application Publication
(10) Pub. No.: US 2023/0259261 A1
(43) Pub. Date: Aug. 17, 2023

(54) Method for Moving Object, Storage Medium and Electronic device

(71) Applicant: NETEASE (HANGZHOU) NETWORK CO.,LTD., Hangzhou, Zhejiang (CN)

(72) Inventor: Jia HAO, Hangzhou, Zhejiang (CN)

(21) Appl. No.: 17/914,777

(22) PCT Filed: Jan. 19, 2021
(86) PCT No.: PCT/CN2021/072721

§ 371 Date: Sep. 27, 2022

(30) Foreign Application Priority Data
Nov. 2, 2020 (CN) 202011205761.2

(51) Int. Cl. G06F 3/04845; G06F 3/0488; G06F 3/04815

(52) U.S. Cl. CPC G06F 3/04845; G06F 3/0488; G06F 3/04815

(57) ABSTRACT

Provided a method for moving an object, a storage medium, and an electronic device. The method may include: position coordinates, in a three-dimensional scene, of a target object to be moved are acquired (S202); in response to a first sliding operation acting on a graphical user interface, a target reference plane in the three-dimensional scene is determined based on the first sliding operation and the position coordinates (S204); and in response to a second sliding operation on the target object the target object is controlled to move on the target reference plane (S206).

### CROSS-REFERENCE TO RELATED APPLICATION

The present disclosure claims priority to Chinese Patent Application No. 202011205761.2, filed to the Chinese Patent Office on Nov. 2, 2020 and title “Method and Apparatus for Moving Object, Storage Medium and Electronic device”, which is incorporated herein by reference in its entirety.

### TECHNICAL FIELD

The present disclosure relates to the field of computers, and in particular, relates to a method for moving an object, a storage medium, and an electronic device.

### BACKGROUND

At present, when an object is to be moved, a fixed direction or a fixed plane may be pre-determined, and then the object is moved according to the fixed direction or the fixed plane.

The method above is common in professional three-dimensional (3D) software at a computer end, and it is necessary to precisely select a coordinate axis or a coordinate plane within a very small range.

### SUMMARY

According to one aspect of the embodiments of the present disclosure, a method for moving an object is provided, wherein a client is running on a terminal device, a graphical user interface is obtained by executing an application on a processor of the terminal device and performing rendering on a touch display of the terminal device, the graphical user interface at least partially includes a three-dimensional scene, and the three-dimensional scene includes at least one target object to be moved; the method may include the following steps: position coordinates, in the three-dimensional scene, of the target object to be moved are acquired; in response to a first sliding operation acting on the graphical user interface, a target reference plane in the three-dimensional scene is determined based on the first sliding operation and the position coordinates; and in response to a second sliding operation on the target object, the target object is controlled to move on the target reference plane.

According to another aspect of the embodiments of the present disclosure, an apparatus for moving an object is further provided, wherein a client is running on a terminal device, a graphical user interface is obtained by executing an application on a processor of the terminal device and performing rendering on a touch display of the terminal device, the graphical user interface at least partially includes a three-dimensional scene, and the three-dimensional scene includes at least one target object to be moved; the apparatus may includes at least one processor, and at least one memory storing a program element, wherein the program element is executed by the at least one processor, and the program element may include: an acquisition component, configured to acquire position coordinates, in the three-dimensional scene, of the target object to be moved; a determination component, configured to determine, in response to a first sliding operation acting on the graphical user interface, a target reference plane in the three-dimensional scene based on the first sliding operation and the position coordinates; and a movement component, configured to control, in response to a second sliding operation on the target object, the target object is controlled to move on the target reference plane.

According to another aspect of the embodiments of the present disclosure, a non-transitory storage medium is further provided. The non-transitory storage medium stores a computer program, wherein when the computer program is run by a processor, a device in which the non-transitory storage medium is located is controlled to perform the method for moving an object in embodiments of the present disclosure.

According to another aspect of the embodiments of the present disclosure, an electronic device is further provided. The electronic device may include: a processor; and a memory, connected to the processor and configured to store executable instructions of the processor, wherein the processor is configured to execute the executable instructions, and the executable instructions may include: position coordinates are acquired, in a three-dimensional scene, of a target object to be moved; in response to a first sliding operation acting on a graphical user interface, a target reference plane in the three-dimensional scene is determined based on the first sliding operation and the position coordinates; and in response to a second sliding operation on the target object, the target object is controlled to move on the target reference plane.

### BRIEF DESCRIPTION OF THE DRAWINGS

FIG. 1 is a structural block diagram of a hardware of a mobile terminal for a method for moving an object according to one embodiment of the present disclosure;

FIG. 2 is a flowchart of a method for moving an object according to one embodiment of the present disclosure;

FIG. 3 is a schematic diagram of moving an article according to the related art;

FIG. 4 is a schematic diagram of adjusting a viewing angle of a virtual camera according to one embodiment of the present disclosure;

FIG. 5 is a schematic diagram of moving an article according to one embodiment of the present disclosure;

FIG. 6 is a schematic diagram of an apparatus for moving an object according to one embodiment of the present disclosure;

FIG. 7 is a structural schematic diagram of a non-transitory storage medium according to one embodiment of the present disclosure; and

FIG. 8 is a structural schematic diagram of an electronic device according to one embodiment of the present disclosure.

### DETAILED DESCRIPTION OF THE EMBODIMENTS

It should be noted that embodiments in the present disclosure and features in the embodiments may be combined with one another without conflicts. Hereinafter, the present disclosure is described in detail below with reference to the accompanying drawings and in conjunction with the embodiments.

In order to enable those skilled in the art to understand technical solutions of the present disclosure better, hereinafter, the technical solutions in the embodiments of the present disclosure will be described below clearly and completely with reference to the accompanying drawings of embodiments of the present disclosure. Obviously, the embodiments as described are only a part of the embodiments of the present disclosure, and are not all the embodiments. Based on the embodiments of the present disclosure, all other embodiments obtained on the premise of no creative work of those of ordinary skill in the art should fall within a scope of protection of the present disclosure.

It should be noted that terms “first”, “second” etc. in the description, claims, and accompanying drawings of the present disclosure are used for distinguishing similar objects, and are not necessarily used for describing a specific sequence or a precedence order. It should be understood that the data used in such a way may be interchanged under appropriate conditions, in order that the embodiments of the present disclosure described herein may be implemented in sequences other than those illustrated or described herein. In addition, terms “include” and “have”, and any variations thereof are intended to cover a non-exclusive inclusion, for example, a process, method, system, product, or device that includes a series of steps or components is not necessarily limited to those steps or components that are clearly listed, but may include other steps or components that are not clearly listed or inherent to such process, method, product, or device.

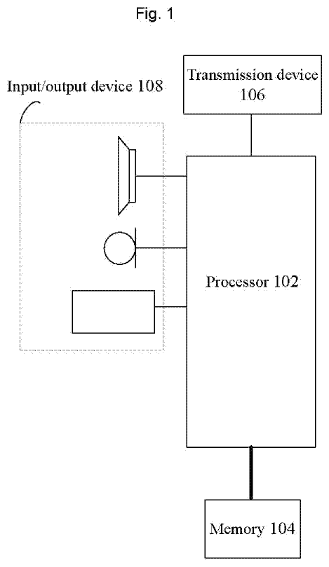

At least one method embodiment provided in the embodiments of the present disclosure may be implemented in a mobile terminal, a computer terminal or a similar computing device. Taking the method embodiments being executed on a mobile terminal as an example, FIG. 1 is a structural block diagram of a hardware of a mobile terminal for a method for moving an object according to one embodiment of the present disclosure. As shown in FIG. 1, a mobile terminal may include at least one (FIG. 1 shows only one) processor 102 (the processors 102 may include, but not limited to a processing apparatus such as a Micro Controller Unit (MCU) or Field Programmable Gate Array (FPGA)) and a memory 104 for storing data. Optionally, the above mobile terminal may further include a transmission device 106 and an input/output device 108 for communication functions. Those skilled in the art would understand that the structure as shown in FIG. 1 is merely illustrative, and does not limit the structure of the above mobile terminal. For example, the mobile terminal may also include more or fewer components than those shown in FIG. 1, or have different configuration from that shown in FIG. 1.

The memory 104 may be used for storing a computer program, for example, a software program and module of application software, such as a computer program corresponding to the method for moving an object in embodiments of the present disclosure; and the processor 102 executes various functional applications and data processing by running the computer program stored in the memory 104, that is to say, the above method is implemented. The memory 104 may include a high-speed random access memory, and may also include a non-transitory memory, such as at least one magnetic storage device, a flash memory or other non-transitory solid-state memories. In some examples, the memory 104 may further include at least one memory remotely located relative to the processor 102, which may be connected to the mobile terminal over a network. Examples of the network may include, but are not limited to an Internet, an intranet, a local area network, a mobile communication network and combinations thereof.

The transmission device 106 is configured to receive or send data via a network. The specific examples above of the network may include a wireless network provided by a communication provider of the mobile terminal. In one example, the transmission device 106 may include a Network Interface Controller (NIC) which may be connected to other network devices through a base station, thereby being able to communicate with the Internet. In one example, the transmission device 106 may be a Radio Frequency (RF) module for communicating with the Internet wirelessly.

In the present embodiment, a method for moving an object running on the above mobile terminal is provided, wherein a client is running on a terminal device, a graphical user interface is obtained by executing an application on a processor of the terminal device and performing rendering on a touch display of the terminal device, the graphical user interface at least partially includes a three-dimensional scene, and the three-dimensional scene includes at least one target object to be moved.

In this present embodiment, the terminal device may be a terminal device such as a smartphone (for example, an Android mobile phone, an iOS mobile phone, etc.), a tablet computer, a palmtop computer, Mobile Internet Devices (MIDs), and a PAD, which are not limited herein. A touch display screen may be a main screen (a two-dimensional screen) of the terminal device and is used for performing rendering to obtain the graphical user interface. The graphical user interface at least partially includes a three-dimensional scene, the three-dimensional scene is a three-dimensional space, and may be a three-dimensional virtual scene, for example, a three-dimensional game scene. In this embodiment, the three-dimensional scene may include at least one target object to be moved, wherein the target object may be a three-dimensional object (article) to be moved.

It is necessary to precisely select a coordinate axis or a coordinate plane within a very small range, which is difficult to be applied to a mobile device; and there is a certain cognitive threshold, so that an ordinary user cannot intuitively learn an operation mode for moving the object, thereby causing a technical problem of low efficiency of moving the object.

No effective solution is proposed at present for the technical problem in the conventional art that low efficiency of moving an object.

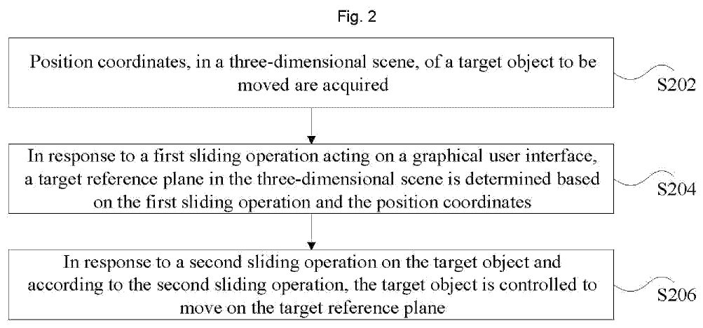

FIG. 2 is a flowchart of a method for moving an object according to one embodiment of the present disclosure. As shown in FIG. 2, the method may include the following steps:

At step S202, position coordinates, in a three-dimensional scene, of a target object to be moved are acquired.

In the technical solution provided by the step S202 of the present disclosure, the target object is an object which is selected in the three-dimensional scene and needs to be moved, for example, the target object may be an object of which a position needs to be adjusted in the three-dimensional scene. In this embodiment, the position coordinates of the target object in the three-dimensional scene are acquired, wherein the position coordinates may be used for determining a specific position of the target object in the three-dimensional scene.

Optionally, in the three-dimensional scene of this embodiment, only the selected object may be moved, while at least one unselected object may not be moved, and movements of multiple objects in the three-dimensional scene are independent of one another. Optionally, in this embodiment, the selected object may be displayed with a first color to indicate that this object is selected, and then may be moved in the three-dimensional scene, for example, the first color is green; and the at least one unselected object may be displayed with a second color to indicate that the at least one unselected object is not selected and may not be moved in the three-dimensional scene, for example, the second color is gray. It should be noted that the first color and the second color herein may be any color as long as they may be distinguished from each other, and are not specifically limited in this embodiment.

At step 3204, in response to a first sliding operation acting on a graphical user interface, a target reference plane in the three-dimensional scene is determined based on the first sliding operation and the position coordinates.

In the technical solution provided by the step S204 of the present disclosure, after the position coordinates are acquired, in a three-dimensional scene, of a target object to be moved, in response to a first sliding operation acting on a graphical user interface, a target reference plane in the three-dimensional scene may be determined based on the first sliding operation and the position coordinates.

In this embodiment, the first sliding operation may be triggered by a user on the graphical user interface through a finger or a mouse, and a sliding start point of the first sliding operation may not act on the target object to be moved. In this embodiment, a straight line or a vector may be determined in the three-dimensional scene based on the first sliding operation, and then a target reference plane is determined in the three-dimensional scene based on the straight line or the vector, and the position coordinates of the target object in the three-dimensional scene, and accordingly, when at least one of the first sliding operation, and the position coordinates of the target object in the three-dimensional scene changes, the target reference plane may also be flexibly adjusted.

In this embodiment, the target reference plane above is a plane to which the target object to be moved refers when moving in the three-dimensional scene, and thus it is not necessary to pre-determine a fixed direction or a fixed plane to move the target object, and it is also not necessary to take an existing object in the three-dimensional scene as a point to which the target object is attached when moving. In this embodiment, the target object may still be moved in cases where there is no other object in the three-dimensional scene; or the target object may be moved independently even in cases where there are other objects in the three-dimensional scene. Optionally, the target reference plane is a plane directly facing the user (a plane directly facing a virtual camera) in the three-dimensional scene, which also conforms to an intuition and expectations of the user. In specific implementations, an initial reference plane may be provided on the graphical user interface according to the position coordinates of the target object, and the initial reference plane is visually displayed, so as to facilitate manual adjustment for the initial reference plane by the user based on the first sliding operation, to determine the target reference plane. For example, a plane intersecting with the target object is generated according to the position coordinates of the target object, as the initial reference plane; and more preferably, an anchor point of the target object may be located on the initial reference plane. In this way, the user may adjust a normal vector of the initial reference plane by means of the first sliding operation, thereby the target reference plane desired by the user is obtained.

At step S206, in response to a second sliding operation on the target object, the target object is controlled to move on the target reference plane.

In the technical solution provided by the step S206 of the present disclosure, after a target reference plane is determined in the three-dimensional scene based on the first sliding operation and the position coordinates, in response to a second sliding operation on the target object, the target object is controlled to move on the target reference plane.

In this embodiment, the second sliding operation may be a sliding operation triggered by the user regarding the target object through a finger or a mouse, the second sliding operation may act on the target object, and also may not act on the target object, and then the target object is controlled to move on the target reference plane according to the second sliding operation, thereby the purpose of controlling the target object to move in the three-dimensional scene is achieved.

In this embodiment, there is a touch point, corresponding the second sliding operation above, on the graphical user interface, for example, the touch point is a point P; and in response to the second sliding operation on the target object, a projection point of the touch point on the determined target reference plane may be acquired, the projection point may also be referred to as a touching point on the target reference plane. Optionally, in this embodiment, an intersection point between the target reference plane and a half line of the touch point along a viewing angle direction of an adjusted viewing angle of a virtual camera may be first determined, and the intersection point is a projection point of the second sliding operation on the reference plane.

After the projection point of the touch point corresponding to the second sliding operation on the target reference plane is acquired, first world coordinates of the projection point in the three-dimensional scene may be determined, and then second world coordinates of the target object in the three-dimensional scene are determined based on the first world coordinates, wherein the first world coordinates may be directly taken as the second world coordinates of the target object moving on the target reference plane, and then the target object is controlled to move on the target reference plane according to the second world coordinates. Therefore, in this embodiment, the second world coordinates of the target object in the three-dimensional scene may be set by means of each frame of the second sliding operation, so that the target object moves in the three-dimensional scene along with the second sliding operation, wherein the second world coordinates are target coordinates that are used for controlling the target object to move on the target reference plane.

Through the steps S202 to S206 of the present disclosure, position coordinates, in a three-dimensional scene, of a target object to be moved are acquired; in response to a first sliding operation acting on a graphical user interface, a target reference plane in the three-dimensional scene is determined based on the first sliding operation and the position coordinates; and in response to a second sliding operation on the target object, the target object is controlled to move on the target reference plane. That is to say, in this embodiment, the target reference plane is determined based on the position coordinates of the target object in the three-dimensional scene and the first sliding operation acting on the graphical user interface, and the target object is controlled to move on the target reference plane, thereby a need to pre-determine a fixed direction or a fixed plane when an object is to be moved is avoided, and a need to take an existing object in the three-dimensional scene as a point to which the target object is attached when moving is also avoided. Thus, a purpose of being able to perform independent movement operation on an object without performing a fine clicking interaction mode may be achieved, and the operation is simple and convenient, being very friendly to a small-sized screen. In this way, the technical problem of low efficiency of moving an object is solved, and the technical effect of increasing the efficiency of moving an object is achieved.

The above method of this present embodiment is further described below.

As an optional implementation method, after the target reference plane in the three-dimensional scene is determined based on the first sliding operation and the position coordinates in the step S204, the method may further include: the target reference plane is graphically displayed in the graphical user interface.

In this embodiment, after the target reference plane in the three-dimensional scene is determined based on the first sliding operation and the position coordinates, the target reference plane may be graphically displayed in the graphical user interface in a process that the target object is controlled to move on the target reference plane according to the second sliding operation. That is to say, the target reference plane is visually presented on the graphical user interface, which may be displaying the target reference plane around the target object in the three-dimensional scene, so that the user clearly and explicitly learns the target reference plane of the target object to be currently moved, facilitating the user to understand a plane to which he/she refers in a blank space in a process of moving the target object.

Hereinafter, the method for determining a target reference plane in the three-dimensional scene based on the first sliding operation and the position coordinates in this embodiment is further introduced.

As an optional implementation method, a target reference plane in the three-dimensional scene is determined based on the first sliding operation and the position coordinates may include: a target space vector in the three-dimensional scene is determined based on the first sliding operation; and the target reference plane is constructed based on the target space vector and the position coordinates.

In this embodiment, the determination of the target reference plane at least requires both a vector and a point in the three-dimensional scene. In this embodiment, the first sliding operation acting on the graphical user interface may include a sliding distance and a sliding direction on the graphical user interface. In this embodiment, a target space vector in the three-dimensional scene may be determined based on the first sliding operation. For example, the sliding distance of the first sliding operation on the graphical user interface is determined as a length of the target space vector, and the sliding direction of the first sliding operation on the graphical user interface is determined as a direction of the target space vector. Optionally, the target space vector may be a direction vector (line of sight) of a viewing angle of the virtual camera in the three-dimensional scene. After a target space vector is determined in the three-dimensional scene, the target reference plane may be constructed based on the target space vector and the position coordinates of the target object in the three-dimensional scene.

As an optional implementation method, the target space vector is a normal vector of the target reference plane, or the target space vector is located on the target reference plane.

In this embodiment, when the target reference plane is constructed by means of the target space vector and the position coordinates of the target object in the three-dimensional scene, the target space vector may be taken as a normal vector of the target reference plane, and then the target reference plane is constructed by means of the normal vector and the position coordinates of the target object in the three-dimensional scene. Optionally, in this embodiment, the target space vector may also be taken as a vector in the target reference plane, and then the target reference plane is constructed by means of the vector in the target reference plane and the position coordinates of the target object in the three-dimensional scene.

Hereinafter, the method that a target space vector in the three-dimensional scene is determined based on the first sliding operation in this embodiment is further introduced.

As an optional implementation method, a target space vector in the three-dimensional scene is determined based on the first sliding operation may include: a two-dimensional vector generated by the first sliding operation on the graphical user interface is determined; a viewing angle of a virtual camera in the three-dimensional scene is adjusted according to the two-dimensional vector; and a direction vector of the adjusted viewing angle is determined, and the target space vector is determined based on the direction vector.

In this embodiment, when the first sliding operation acts on the graphical user interface, a two-dimensional vector is generated on the graphical user interface, and the viewing angle of the virtual camera in the three-dimensional scene may be adjusted according to the two-dimensional vector, and the viewing angle is an angle of the virtual camera in the three-dimensional scene, wherein the virtual camera is a camera in the three-dimensional scene. Optionally, in this embodiment, a horizontal component vector of the two-dimensional vector may be used for controlling the virtual camera to make a surrounding motion around one point in the three-dimensional scene, and a vertical component vector of the two-dimensional vector may be used for controlling the virtual camera to make a pitching motion, so that the viewing angle of the virtual camera in the three-dimensional scene is adjusted by the virtual camera performing the surrounding motion and the pitching motion in the three-dimensional scene. One point above in the three-dimensional scene may be an intersection point between a direction vector of the viewing angle of the virtual camera and a certain plane in the three-dimensional scene, and the certain plane may be a physical plane closest to the virtual camera, and may also be a fixed reference plane in the three-dimensional scene.

After the viewing angle of the virtual camera in the three-dimensional scene is determined, a direction vector of the adjusted viewing angle may be determined, and then the target space vector is determined based on the direction vector, so as to construct the target reference plane based on the target space vector and the position coordinates of the target object in the three-dimensional scene, thereby the purpose of determining a target reference plane by means of change in the direction vector of the viewing angle of the virtual camera is achieved.

Optionally, in this embodiment, in a process of the target object moving on the target reference plane, the adjusted viewing angle of the virtual camera is fixed.

Optionally, in this embodiment, when the viewing angle of the virtual camera in the three-dimensional scene is adjusted according to the two-dimensional vector, the adjustment of the viewing angle of the virtual camera in the three-dimensional scene may be stopped when the viewing angle is adjusted to a viewing angle which the user considers satisfactory. It should be noted that the adjustment of the viewing angle of the virtual camera in the three-dimensional scene is not specifically limited in this embodiment, and according to the viewing angle of the virtual camera, a system always selects a plane directly facing the virtual camera, as the target reference plane. A person habitually chooses to make the viewing angle of the virtual camera parallel to the plane to be adjusted, and thus the target reference plane will also conform to the user's expectation that the reference plane directly faces him/her.

In this embodiment, an included angle between the direction vector of the viewing angle of the virtual camera and the target reference plane that needs to be finally determined is a pitching angle of the virtual camera. In cases where the pitching angle and the position of the one point in the three-dimensional scene remain unchanged, the virtual camera may rotate in the target reference plane around the one point in the three-dimensional scene according to the normal vector of the target reference plane. That is to say, the virtual camera performs the surrounding motion, and a variable of the surrounding motion may be a change of an included angle between a plane formed by the direction vector of the viewing angle of the virtual camera and the normal vector of the one point in the three-dimensional scene on the target reference plane, and any one plane parallel to the normal vector.

Hereinafter, the method that the target space vector is determined based on the direction vector in this embodiment is introduced.

As an optional implementation method, the target space vector is determined based on the direction vector may include: included angles between the direction vector and each of multiple coordinate axes respectively are acquired, to obtain multiple included angles, wherein a target coordinate system may include the multiple coordinate axes; and a space vector of a coordinate axis corresponding to the minimum included angle among the multiple included angles is determined as the target space vector.

In this embodiment, the included angles between the direction vector of the viewing angle of the virtual camera and the multiple coordinate axes respectively of the target coordinate system may be acquired first, to obtain the multiple included angles. For example, the multiple coordinate axes are six coordinate axes (x,-x, y,-y, z,-z), and six included angles are obtained. Then the minimum included angle is determined among the multiple included angles, and a space vector of a coordinate axis corresponding to the minimum included angle is acquired and determined as the target space vector.

Optionally, the target coordinate system in this embodiment may be a world coordinate system; and also, in cases where an application scene itself has a strong visual reference, for example, if an additional facility needs to be built on an existing visual reference object, a reference coordinate system may be established by using the existing visual reference object, wherein the visual reference object may be a space station, and the reference coordinate system is a non-fixed world coordinate system.

As an optional implementation method, the target reference plane is constructed based on the target space vector and the position coordinates may include: multiple planes of which normal vectors are the target space vector are acquired in the three-dimensional scene, to obtain a set of planes; and the target reference plane is determined based on a plane, selected from the set of planes, intersecting with the position coordinates.

In this embodiment, the target space vector may be taken as a normal vector, and the normal vector may be a normal vector of multiple planes (the multiple planes are parallel) in the three-dimensional scene, thereby the set of planes including the multiple planes is obtained, and then a plane is selected from the set of planes, as the target reference plane. Optionally, in this embodiment, the target reference plane of this embodiment may be determined based on a plane, selected from the set of planes, intersecting with the position coordinates of the target object in the three-dimensional scene.

As an optional implementation method, the target reference plane is determined based on the plane, selected from the set of planes, intersecting with the position coordinates may include: the plane, selected from the set of planes, intersecting with the position coordinates is determined as the target reference plane; or the plane, selected from the set of planes, intersecting with the position coordinates is rotated, and the rotated plane is determined as the target reference plane.

In this embodiment, after the plane intersecting with the position coordinates of the target object in the three-dimensional scene is determined from the set of planes, the plane may be directly determined as the target reference plane. Optionally, in this embodiment, the determined target reference plane may also be rotated according to actual application situations, that is to say, in the set of planes, a plane intersecting with the position coordinates of the target object in the three-dimensional scene is continuously rotated, and then the rotated plane is taken as the final target reference plane.

It should be noted that it is only an example of the embodiment of the present disclosure that when the target reference plane is determined, a plane, intersecting with the position coordinates, in the set of planes is determined as the target reference plane, or the determined target reference plane is continuously rotated, and the rotated plane is taken as the final target reference plane. Any plane that may be used for determining the target reference plane so that the target object moves in the three-dimensional scene falls within the scope of this embodiment. For example, a plane, which passes through the target space vector and the position coordinates of the target object in the three-dimensional scene, in the three-dimensional scene is determined as the target reference plane, and they will not be illustrated one by one herein.

As an optional implementation method, the position coordinates are located on the target reference plane, or reference coordinate points determined according to the position coordinates are located on the target reference plane.

In this embodiment, the position coordinates of the target object in the three-dimensional scene may be located on the target reference plane, and in this way, a plane, selected from the set of planes, intersecting with the position coordinates may be determined as the target reference plane; or a plane, which passes through the target space vector and the position coordinates of the target object in the three-dimensional scene, in the three-dimensional scene is determined as the target reference plane. Optionally, in this embodiment, other reference coordinate points may be determined according to the position coordinates of the target object in the three-dimensional scene, and a plane, intersecting with the reference coordinate points, in the set of planes may be determined as the target reference plane; or, a plane, passing through the target space vector and the reference coordinate points, in the three-dimensional scene is determined as the target reference plane. Thus, in this embodiment, an purpose of determining the target reference plane may be achieved by means of the target space vector and the position coordinates of the target object in the three-dimensional scene or other reference coordinate points.

As an optional implementation method, position coordinates, in a three-dimensional scene, of a target object to be moved are acquired in step S202 may include: an anchor point of the target object in the three-dimensional scene is acquired; and coordinates of the anchor point are determined as the position coordinates.

In this embodiment, there are many points on the target object, wherein a point for determining the position of the target object in the three-dimensional scene is the anchor point. That is to say, the anchor point is used for positioning the target object, and in this embodiment, the coordinates of the anchor point may be determined as the position coordinates, for determining the target reference plane.

As an optional implementation method, after the target reference plane in the three-dimensional scene is determined based on the first sliding operation and the position coordinates in the step S204, the method may further includes: a default reference plane in the three-dimensional scene is updated as the target reference plane, wherein the default reference plane is a reference plane where the target object is located when the target object moves, before the target reference plane is determined based on the first sliding operation and the position coordinates.

In this embodiment, there is a default reference plane in the three-dimensional scene at the beginning, and the target object may move on the default reference plane at the beginning. Moreover, when the first sliding operation acting on the graphical user interface is received, the target reference plane may be determined in response to the first sliding operation and based on the first sliding operation and the position coordinates of the target object in the three-dimensional scene, and the reference plane is replaced with the default reference plane. In response to a second sliding operation on the target object, the target object is controlled to move on the target reference plane.

Optionally, in a process of controlling, according to the second sliding operation, the target object to move on the target reference plane, if the first sliding operation acting on the graphical user interface is received again, the target reference plane is re-determined in response to the first sliding operation again and based on the first sliding operation and the position coordinates of the target object in the three-dimensional scene, and then the previous target reference plane is updated by means of the re-determined target reference plane, and then in response to the second sliding operation on the target object and according to the second sliding operation, the target object is controlled to move on the re-determined target reference plane.

As an optional implementation method, after the target object is controlled to stop movement on the target reference plane according to the second sliding operation, the method may further include: the target reference plane is hidden in the graphical user interface.

In this embodiment, after the target object is controlled to stop movement on the target reference plane according to the second sliding operation, the target reference plane may be hidden, to make the graphical user interface be simple.

In the related art, a target object is usually moved when a fixed direction or plane is provided. However, in this operation method, a coordinate axis or a coordinate plane needs to be precisely selected within a very small range, which is difficult to be applied to a mobile platform; in addition, there is a certain cognitive threshold, so that an ordinary player cannot intuitively learn the operation method. In addition, in the related art, the target object is usually attached to any plane to move freely, although the method may operate the target object relatively freely, it is necessary that an existing object is served as a point to which the target object is attached when moving, which cannot satisfy requirements when the position of the target object is to be adjusted in a blank scene or the position of the target object needs to be adjusted independently.

However, the method for moving an object in the present disclosure is compatible with a mobile device, in which a target reference plane may be determined according to an adjusted viewing angle of a virtual camera in a three-dimensional scene (the reference plane is determined by means of viewing angle change), and a target object is controlled to move on the target reference plane. The method does not require a fine clicking interaction mode, and an purpose of being able to perform independent movement operation on the target object in the three-dimensional scene is achieved; and the method also does not need to independently pre-select a movement plane or direction, and the operation is simple and convenient, being very friendly to a small-sized screen, and being able to adapt to all requirements that it is necessary to move a three-dimensional object on a two-dimensional screen, thereby the technical problem of low efficiency of moving an object is solved, and the technical effect of increasing the efficiency of moving an object is achieved.

A preferred embodiment of this embodiment will be further introduced below, and specifically, the target object being an article is taken as an example for description.

In the related art, when an operation of moving an article is performed, a fixed direction or plane may be provided in advance, and then the article is moved.

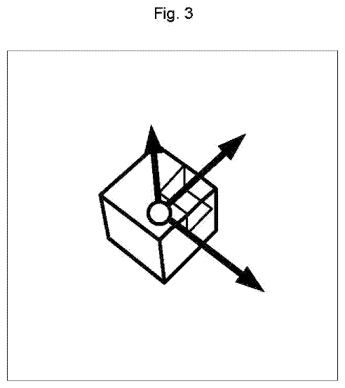

FIG. 3 is a schematic diagram of moving an article according to the related art. As shown in FIG. 3, there is a three-dimensional coordinate system in a three-dimensional space where an article is located in. A fixed direction or plane may be pre-determined in the three-dimensional coordinate system, and then the article is moved based on the determined fixed direction or plane.

The method is common in professional 3D software at a computer end, and in this operation method, a coordinate axis or a coordinate plane needs to be precisely selected within a very small range, which is difficult to be applied to a mobile device; in addition, there is a certain cognitive threshold, so that an ordinary player cannot intuitively learn the operation mode.

In the art, it is also common that the article is attached in any plane to move freely. Although the method can move the article relatively freely, an existing article needs to be taken as a point to which the article is attached when moving. The method cannot satisfy requirements when the position of an article is to be adjusted in a blank scene or the position of the article needs to be adjusted independently.

With regard to the problem, the embodiment may be compatible with a mobile device, and does not require a fine clicking interaction mode; an independent movement operation may be performed on the article, and this movement operation does not require reference coordinates provided by means of other articles, may be performed in the blank scene, and is an intuitive and easy-to-learn operation mode. The method in this embodiment is further described below.

In the embodiment, by performing a sliding operation on a screen (there is no article at a start point of the sliding operation), the angle of a virtual camera in a 3D space may be adjusted (i.e. adjusting a viewing angle), and a direction vector of the viewing angle of the virtual camera is acquired; included angles between the direction vector and each of six axial directions (x, −x, y, −y, z, −z) respectively of world coordinates are calculated, to obtain six included angles; and a coordinate axis corresponding to a minimum included angle among the six included angles is determined, and a space vector of the coordinate axis corresponding to the minimum included angle may be taken as a normal vector. A target reference plane is determined based on an anchor point of the article or other reference coordinate points.

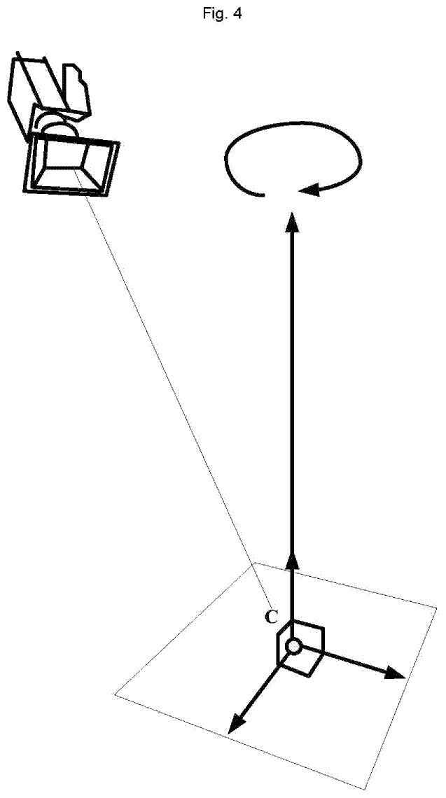

FIG. 4 is a schematic diagram of adjusting a viewing angle of a virtual camera according to one embodiment of the present disclosure. As shown in FIG. 4, an intersection point between the direction vector of a viewing angle of the virtual camera and a certain plane in the 3D space is denoted as C, wherein the certain plane may be a physical plane closest to the virtual camera, or may be a fixed reference plane in the space.

In this embodiment, an included angle between a direction vector of the viewing angle of the virtual camera and the target reference plane is a pitching angle of the virtual camera.

The virtual camera can rotate around the point C on the target reference plane according to the normal vector in cases where the pitching angle and the position of the point C remain unchanged. That is to say, the virtual camera makes a surrounding motion, wherein a variable of the virtual camera making a surrounding motion is a change of an included angle between a plane formed by a line of sight of the virtual camera and the normal vector of the point C on the target reference plane, and any one plane parallel to the normal vector.

In this embodiment, the sliding operation generates a two-dimensional vector on the screen, wherein a horizontal component vector of the two-dimensional vector is used for controlling the virtual camera to make a surrounding motion around the point C, and a vertical component vector of the two-dimensional vector is used for controlling the virtual camera to make a pitching motion.

In this embodiment, the viewing angle of the virtual camera in the 3D space being adjusted, may be that when the viewing angle being adjusted to a viewing angle which the user considers satisfactory, the viewing angle being stopped adjusting. It should be noted that this embodiment does not specifically limit the adjustment of the viewing angle of the virtual camera, and the system always selects a plane directly facing the virtual camera according to the current viewing angle of the virtual camera. A person habitually chooses to make the viewing angle parallel to the plane to be adjusted, and thus the target reference plane will also conform to the user's expectation that the plane directly faces him/her.

In this embodiment, when the user starts a touch sliding operation on the screen by taking the article as a start point, the article may be moved, and in this case, the viewing angle of the virtual camera no longer changes. A specific principle may be that a half line of a touch point of a finger (or a mouse) on the screen along the direction of the viewing angle of the virtual camera is determined, and an intersection point between the half line and the target reference plane obtained in the previous step is acquired, and the intersection point is denoted as P, that is to say, the point P is a projection point (touching point) of the finger (mouse) on the target reference plane, and the coordinates of the point P is taken as target coordinates of the article moving on the target reference plane. Optionally, in this embodiment, the world coordinates of the article are set as the coordinates of the point P according to each frame of the sliding operation performed by the user, so that the article moves along with the finger, thereby the purpose of moving the article is achieved.

In this embodiment, in a process of moving the article, the target reference plane may be visually presented, and a specific method for generating the target reference plane is to display the target reference plane around the article, so that the user clearly and explicitly learns the target reference plane to which an article currently moved by himself/herself refers. After moving of the article is completed, the target reference plane may be hidden.

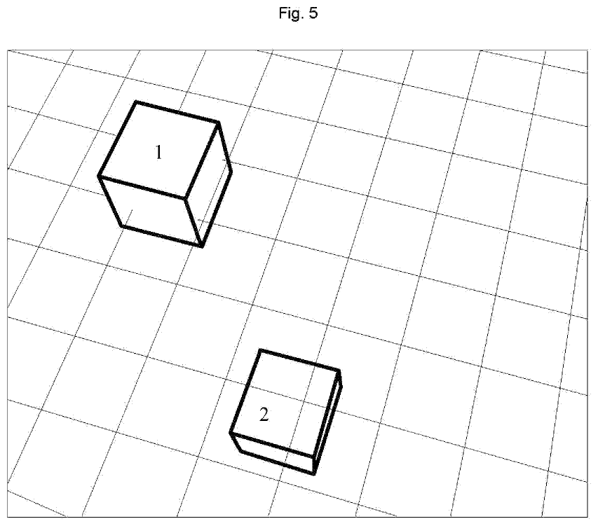

FIG. 5 is a schematic diagram of moving an article according to one embodiment of the present disclosure. As shown in FIG. 5, article 1 is a selected article to be moved, and in this embodiment, only the selected article may be moved. Article 1 and article 2 are independent from each other, and when article 1 is moved, article 2 facilitates a user to perceive a movement of article 1. That is to say, article 1 and article 2 may refer to each other. If only one article 1 is placed in the three-dimensional scene, it is not easy for the user to feel the movement effect of the article 1.

It should be noted that in the method for moving an article in this embodiment, while moving a virtual camera, a reference plane of the article to be moved is selected. No matter whether by means of a direction vector of a viewing angle of the virtual camera in world coordinates or by means of other methods, an optimal target reference plane at a current viewing angle needs to be obtained by calculation. In this embodiment, a coordinate axis which has the minimum included angle with the direction vector of the viewing angle of the virtual camera is selected, and a plane which takes the coordinate axis as a normal vector is determined as the target reference plane.

In this embodiment, the condition for selecting the target reference plane may also change according to different requirements. For example, in this embodiment, the selected target reference plane may also continue to be rotated according to practical application situations, and the rotated target reference plane is taken as the final target reference plane. In this embodiment, an application scene itself may have a strong visual reference, for example, if an additional facility needs to be built on a space station, a coordinate system, rather than a fixed world coordinate system, may be established by using an existing visual reference (i.e. the space station), and the target reference plane is calculated by means of the direction vector (line of sight) of the viewing angle of the virtual camera and the coordinate system.

It should be noted that the method for moving an article in this embodiment may involve a single-finger sliding touch operation, and does not need to perform independent pre-selection on a plane or direction in which the article moves, the operation being simple and convenient, and being very friendly to a small-sized screen. This embodiment can enable a player to move an article on a plane directly facing himself/herself, which is very intuitive; therefore, a learning cost of the operation solution of this embodiment is very low, and a problem that a article reference must be provided and an article cannot be operated independently are avoided, having a wider application range, and being able to basically adapt to all requirements of moving a 3D article on a 2D screen, thereby the technical problem of low efficiency of moving an object is solved, and the technical effect of increasing the efficiency of moving an object is achieved.

Embodiments of the present disclosure further provide an apparatus for moving an object, wherein a client is running on a terminal device, a graphical user interface is obtained by executing an application on a processor of the terminal device and performing rendering on a touch display of the terminal device, the graphical user interface at least partially may include a three-dimensional scene, and the three-dimensional scene may include at least one target object to be moved. It should be noted that the apparatus for moving an object in this embodiment may include: at least one processor, and at least one memory storing a program element, wherein the program element is executed by the processors, and the program element may include: an acquisition component, a determination component and a movement component. It should be noted that the apparatus for moving an object in this embodiment may be used to perform the method for moving an object as shown in FIG. 2 in the embodiments of the present disclosure.

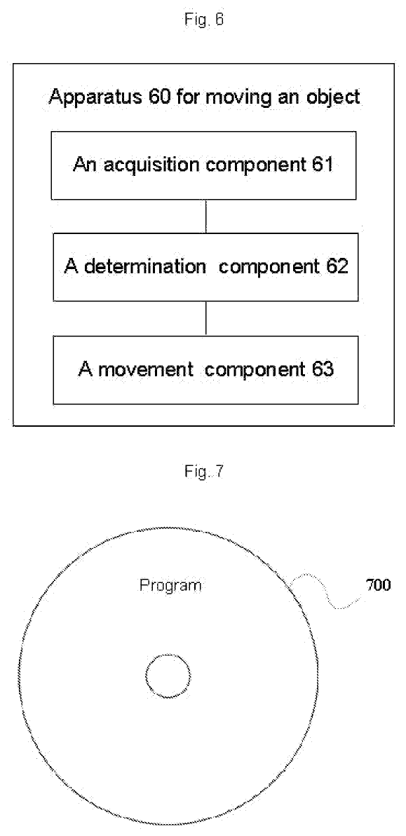

FIG. 6 is a schematic diagram of an apparatus for moving an object according to one embodiment of the present disclosure. As shown in FIG. 6, the apparatus 60 for moving an object may include: an acquisition component 61, a determination component 62 and a movement component 63.

The acquisition component 61 is configured to acquire position coordinates, in the three-dimensional scene, of the target object to be moved.

The determination component 62 is configured to determine, in response to a first sliding operation acting on the graphical user interface, a target reference plane in the three-dimensional scene based on the first sliding operation and the position coordinates.

The movement component 63 is configured to control, in response to a second sliding operation on the target object, the target object to move on the target reference plane.

It should be noted herein that the acquisition component 61, the determination component 62 and the movement component 63 may be run in a terminal as a part of the apparatus, and functions implemented by the components may be executed by a processor in the terminal. The terminal device may be a terminal device such as a smartphone (for example, an Android mobile phone, an iOS mobile phone, etc.), a tablet computer, a palmtop computer, Mobile Internet Devices (MIDs for short), and a PAD.

Optionally, the apparatus may further include: a display component, configured to graphically display the target reference plane in the graphical user interface after the target reference plane in the three-dimensional scene is determined based on the first sliding operation and the position coordinates.

It should be noted herein that the display component may be run in the terminal as a part of the apparatus, and a function implemented by the component may be executed by the processor in the terminal.

Optionally, the determination component 62 may further include: a first determination component, configured to determine a target space vector in the three-dimensional scene based on the first sliding operation; and a construction component, configured to construct a target reference plane based on the target space vector and the position coordinates.

Optionally, the target space vector is a normal vector of the target reference plane, or the target space vector is located on the target reference plane.

Optionally, the first determination component is configured to determine the target space vector in the three-dimensional scene based on the first sliding operation by means of the following steps: a two-dimensional vector generated by the first sliding operation on the graphical user interface is determined; a viewing angle of a virtual camera is adjusted in the three-dimensional scene according to the two-dimensional vector; and a direction vector of the adjusted viewing angle is determined, and a target space vector is determined based on the direction vector.

Optionally, the first determination component is configured to determine the target space vector based on the direction vector by means of the following steps: included angles between the direction vector and each of multiple coordinate axes respectively are acquired, to obtain multiple included angles, wherein a target coordinate system may include the multiple coordinate axes; and a space vector of the coordinate axis corresponding to the minimum included angle among the multiple included angles, is determined as the target space vector.

Optionally, the construction component may include: a first acquisition component, configured to acquire, in the three-dimensional scene, multiple planes of which normal vectors are the target space vector, to obtain a set of planes; and a second determination component configured to determine the target reference plane based on a plane, selected from the set of planes, intersecting with the position coordinates.

Optionally, the second determination component is configured to determine the target reference plane based on a plane, selected from the set of planes, intersecting with the position coordinates by means of the following steps: the plane, selected from the set of planes, intersecting with the position coordinates is determined as the target reference plane; or the plane, selected from the set of planes, intersecting with the position coordinates is rotated, and the rotated plane is determined as the target reference plane.

Optionally, the position coordinates are located on the target reference plane, or reference coordinate points determined according to the position coordinates are located on the target reference plane.

Optionally, the acquisition component 61 may include: a second acquisition component, configured to acquire an anchor point of the target object in the three-dimensional scene; and a third determination component, configured to determine coordinates of the anchor point as the position coordinates.

Optionally, the apparatus may further includes: an update component, configured to update a default reference plane in the three-dimensional scene as the target reference plane after the target reference plane in the three-dimensional scene is determined based on the first sliding operation and the position coordinates, wherein the default reference plane is a reference plane where the target object is located when the target object moves, before the target reference plane is determined based on the first sliding operation and the position coordinates.

It should be noted herein that the update component may be run in the terminal as a part of the apparatus, and a function implemented by the component may be executed by the processor in the terminal.

Optionally, the apparatus may further include: a hiding component configured to hide the target reference plane in the graphical user interface, after the target object is controlled to stop movement on the target reference plane according to the second sliding operation.

It should be noted herein that the hiding component may be run in the terminal as a part of the apparatus, and a function implemented by the component may be executed by the processor in the terminal.

The apparatus for moving an object of this embodiment is compatible with a mobile device. A target reference plane is determined by means of position coordinates of the target object in the three-dimensional scene and the first sliding operation acting on the graphical user interface, and the target object is controlled to move on the target reference plane, thereby a need to pre-determine a fixed direction or a fixed plane when an object is to be moved is avoided, and a need to take an existing object in the three-dimensional scene as a point to which the target object is attached when moving is also avoided. Thus, a purpose of being able to perform independent movement operation on an object without performing a fine clicking interaction mode may be achieved, and an operation is simple and convenient, being very friendly to a small-sized screen, thereby the technical problem of low efficiency of moving an object is solved, and the technical effect of increasing the efficiency of moving an object is achieved.

Embodiments of the present disclosure further provide a non-transitory storage medium. The non-transitory storage medium stores a computer program, wherein when the computer program is run by a processor, a device in which the non-transitory storage medium is located is controlled to perform the method for moving an object in embodiments of the present disclosure.

Each functional component provided in the embodiments of the present disclosure may be run in the apparatus for moving an object or a similar computing apparatus, and may also be stored as a part of the non-transitory storage medium.

FIG. 7 is a structural schematic diagram of a non-transitory storage medium according to one embodiment of the present disclosure. As shown in FIG. 7, a program product 700 according to embodiments of the present disclosure is described, wherein a computer program is stored on the program product, and the computer program implements program codes of the following steps when being performed by a processor:

position coordinates, in a three-dimensional scene, of a target object to be moved are acquired;

in response to a first sliding operation acting on a graphical user interface, a target reference plane in the three-dimensional scene is determined based on the first sliding operation and the position coordinates; and

in response to a second sliding operation on the target object, the target object is controlled to move on the target reference plane.

Optionally, when being performed by the processor, the computer program may further implement program codes of the following step: the target reference plane in the graphical user interface is graphically displayed after the target reference plane in the three-dimensional scene is determined based on the first sliding operation and the position coordinates.

Optionally, when being performed by the processor, the computer program may further implement program codes of the following steps: a target space vector in the three-dimensional scene is determined based on the first sliding operation; and the target reference plane is constructed based on the target space vector and the position coordinates.

Optionally, when being performed by the processor, the computer program may further implement program codes of the following steps: a two-dimensional vector generated by the first sliding operation on the graphical user interface is determined; a viewing angle of a virtual camera in the three-dimensional scene is adjusted according to the two-dimensional vector; and a direction vector of the adjusted viewing angle is determined, and the target space vector is determined based on the direction vector.

Optionally, when being performed by the processor, the computer program may further implement program codes of the following steps: included angles between the direction vector and each of multiple of coordinate axes respectively is acquired, to obtain multiple included angles, wherein a target coordinate system comprises the multiple coordinate axes; and a space vector of the coordinate axis corresponding to the minimum included angle among the multiple included angles, is determined as the target space vector.

Optionally, when being performed by the processor, the computer program may further implements program codes of the following steps: multiple planes of which normal vectors are the target space vector are acquired in the three-dimensional scene, to obtain a set of planes; and the target reference plane is determined based on a plane, selected from the set of planes, intersecting with the position coordinates.

Optionally, when being performed by the processor, the computer program may further implements program codes of the following steps: the plane, selected from the set of planes, intersecting with the position coordinates is determined as the target reference plane; or the plane, selected from the set of planes, intersecting with the position coordinates is rotated, and the rotated plane is determined as the target reference plane.

Optionally, when being performed by the processor, the computer program may further implement program codes of the following steps: an anchor point of the target object in the three-dimensional scene is acquired; and coordinates of the anchor point is determined as the position coordinates.

Optionally, when being performed by the processor, the computer program may further implement program codes of the following step: a default reference plane in the three-dimensional scene is updated as the target reference plane after the target reference plane in the three-dimensional scene is determined based on the first sliding operation and the position coordinates, wherein the default reference plane is a reference plane where the target object is located when the target object moves, before the target reference plane is determined based on the first sliding operation and the position coordinates.

Optionally, when being performed by the processor, the computer program may further implement program codes of the following step: the target reference plane in the graphical user interface is hidden after the target object is controlled to stop movement on the target reference plane according to the second sliding operation.

Optionally, for specific examples in the present embodiment, reference may be made to the examples described in the described embodiments, and thus they will not be repeated in the present embodiment.

Program codes included in the non-transitory storage medium may be transmitted via any suitable medium, including but not limited to wireless, wired, optical cable, radio frequency, etc., or any suitable combination thereof.

Optionally, in the present embodiment, the non-transitory storage medium may include, but is not limited to, various media that can store a computer program, such as a USB flash drive, a Read-Only Memory (ROM), a Random Access Memory (RAM), a removable hard disk, a magnetic disk, or an optical disc.

Embodiments of the present disclosure further provide an electronic device. The electronic device may include: a processor; and a memory, connected to the processor and configured to store at least one executable instruction of the processor, wherein the processor is configured to execute the at least one executable instruction, and the at least one executable instruction may include: position coordinates, in a three-dimensional scene, of a target object to be moved are acquired; in response to a first sliding operation acting on a graphical user interface, a target reference plane in the three-dimensional scene is determined based on the first sliding operation and the position coordinates; and in response to a second sliding operation on the target object, the target object is controlled to move on the target reference plane.

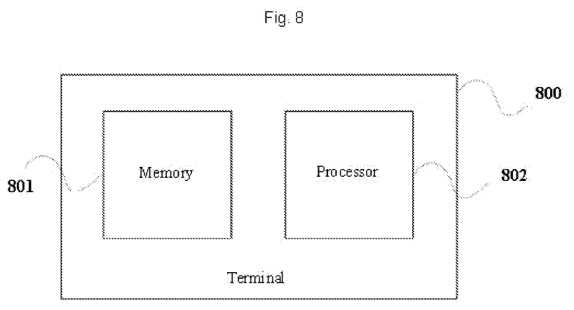

FIG. 8 is a structural schematic diagram of an electronic device according to one embodiment of the present disclosure. As shown in FIG. 8, the electronic device 800 in this embodiment may include: a memory 801 and a processor 802. The memory 801 is configured to store at least one executable instruction of the processor, and the at least one executable instruction may be a computer program; and the processor 802 is configured to implement the following steps by executing the executable instructions:

position coordinates, in a three-dimensional scene, of a target object to be moved are acquired;

in response to a first sliding operation acting on a graphical user interface, a target reference plane in the three-dimensional scene is determined based on the first sliding operation and the position coordinates; and

in response to a second sliding operation on the target object, the target object is controlled to move on the target reference plane.

Optionally, the processor 802 is further configured to implement the following step by executing the executable instructions: the target reference plane is graphically displayed in the graphical user interface after the target reference plane in the three-dimensional scene is determined based on the first sliding operation and the position coordinates.

Optionally, the processor 802 is further configured to implement the following steps by executing the executable instructions: a target space vector in the three-dimensional scene is determined based on the first sliding operation; and the target reference plane is constructed based on the target space vector and the position coordinates.

Optionally, the processor 802 is further configured to implement the following steps by executing the executable instructions: a two-dimensional vector generated by the first sliding operation on the graphical user interface is determined; a viewing angle of a virtual camera in the three-dimensional scene is adjusted according to the two-dimensional vector; and a direction vector of the adjusted viewing angle is determined, and the target space vector is determined based on the direction vector.

Optionally, the processor 802 is further configured to implement the following steps by executing the executable instructions: included angles between the direction vector and each of multiple coordinate axes respectively is acquired, to obtain multiple included angles, wherein a target coordinate system comprises the multiple coordinate axes; and a space vector of the coordinate axis corresponding to the minimum included angle among the multiple included angles, is determined as the target space vector.

Optionally, the processor 802 is further configured to implement the following steps by executing the executable instructions: multiple planes of which normal vectors are the target space vector are acquired in the three-dimensional scene, to obtain a set of planes; and the target reference plane is determined based on a plane, selected from the set of planes, intersecting with the position coordinates.

Optionally, the processor 802 is further configured to implement the following steps by executing the executable instructions: the plane, selected from the set of planes, intersecting with the position coordinates is determined as the target reference plane; or the plane, selected from the set of planes, intersecting with the position coordinates is rotated, and the rotated plane is determined as the target reference plane.

Optionally, the processor 802 is further configured to implement the following steps by executing the executable instructions: an anchor point of the target object in the three-dimensional scene is acquired; and coordinates of the anchor point is determined as the position coordinates.

Optionally, the processor 802 is further configured to implement the following steps by executing the executable instructions: a default reference plane in the three-dimensional scene is updated as the target reference plane after the target reference plane in the three-dimensional scene is determined based on the first sliding operation and the position coordinates, wherein the default reference plane is a reference plane where the target object is located when the target object moves, before the target reference plane is determined based on the first sliding operation and the position coordinates.

Optionally, the processor 802 is further configured to implement the following steps by executing the executable instructions: the target reference plane in the graphical user interface is hidden after the target object is controlled to stop movement on the target reference plane according to the second sliding operation.

Optionally, the electronic device may further include a transmission device and an input/output device, wherein the transmission device is connected to the processor, and the input/output device is connected to the processor.

In optional embodiments, the electronic device may further include: at least one processor; and memory resources, represented by the memory and for storing at least one instruction, such as an application program, executable by a processing component. The application program stored in the memory may include at least one components each corresponding to one group of instructions. In addition, the processing component is configured to execute the at least one instruction, to implement the method for moving an object.

The electronic device may further include: a power source component, which is configured to perform power management on the electronic device; a wired or wireless network interface, configured to connect the electronic device to a network; and an input/output (I/O) interface. The electronic device may operate based on an operating system stored in a memory, such as Android, iOS, Windows, Mac OS X, Unix, Linux, FreeBSD or similar operating systems.

A person of ordinary skill in the art would understand that the structure as shown in FIG. 8 is merely exemplary. The electronic device may be an electronic device such as a smartphone, a tablet computer, a palmtop computer, Mobile Internet Devices (MIDs), and a PAD. FIG. 8 does not limit the structure of the electronic device. For example, the electronic device may also include more or fewer components (such as a network interface, a display apparatus, etc.) than those as shown in FIG. 8, or have different configuration from that as shown in FIG. 8.

Obviously, a person skilled in the art would understand that the components or steps in the present disclosure may be implemented by using a general-purpose computing apparatus, may be centralized on a single computing apparatus, or may be distributed on a network composed of multiple computing apparatuses. Optionally, the components or steps may be implemented by using executable program codes of the computing apparatus, and thus, the program codes may be stored in a storage apparatus and executed by the computing apparatus, and in some cases, the shown or described steps may be executed in a sequence different from that shown herein, or the components or steps are manufactured into integrated circuit modules, or multiple modules or steps therein are manufactured into a single integrated circuit module for implementation. Thus, the present disclosure is not limited to any specific hardware and software combinations.

The content above merely relates to preferred embodiments of the present disclosure, and is not intended to limit the present disclosure. For a person skilled in the art, the present disclosure may have various modifications and changes. Any modifications, equivalent replacements, improvements, etc. made within the principle of the present disclosure shall all fall within the scope of protection of the present disclosure.

What is claimed is:

1. A method for moving an object, wherein a client is running on a terminal device, a graphical user interface is obtained by executing an application on a processor of the terminal device and performing rendering on a touch display of the terminal device, the graphical user interface at least partially comprises a three-dimensional scene, and the three-dimensional scene comprises at least one target object to be moved; the method comprising:
acquiring position coordinates, in the three-dimensional scene, of the target object to be moved;
in response to a first sliding operation acting on the graphical user interface, determining a target reference plane in the three-dimensional scene based on the first sliding operation and the position coordinates; and
in response to a second sliding operation on the target object controlling the target object to move on the target reference plane.

2. The method as claimed in claim 1, wherein after determining the target reference plane in the three-dimensional scene based on the first sliding operation and the position coordinates, the method further comprises:
graphically displaying the target reference plane in the graphical user interface.

3. The method as claimed in claim 1, wherein determining the target reference plane in the three-dimensional scene based on the first sliding operation and the position coordinates comprises:
determining a target space vector in the three-dimensional scene based on the first sliding operation; and
constructing the target reference plane based on the target space vector and the position coordinates.

4. The method as claimed in claim 3, wherein the target space vector is a normal vector of the target reference plane, or the target space vector is located on the target reference plane.

5. The method as claimed in claim 3, wherein determining the target space vector in the three-dimensional scene based on the first sliding operation comprises:
determining a two-dimensional vector generated by the first sliding operation on the graphical user interface;
adjusting a viewing angle of a virtual camera in the three-dimensional scene according to the two-dimensional vector; and
determining a direction vector of the adjusted viewing angle, and determining the target space vector based on the direction vector.

6. The method as claimed in claim 5, wherein determining the target space vector based on the direction vector comprises:
acquiring included angles between the direction vector and each of a plurality of coordinate axes respectively, to obtain a plurality of included angles, wherein a target coordinate system comprises the plurality of coordinate axes; and
determining a space vector of the coordinate axis corresponding to the minimum included angle among the plurality of included angles, as the target space vector.

7. The method as claimed in claim 3, wherein constructing the target reference plane based on the target space vector and the position coordinates comprises:
acquiring, in the three-dimensional scene, a plurality of planes of which normal vectors are the target space vector, to obtain a set of planes; and
determining the target reference plane based on a plane, selected from the set of planes, intersecting with the position coordinates.

8. The method as claimed in claim 7, wherein determining the target reference plane based on a plane, selected from the set of planes, intersecting with the position coordinates comprises:
determining the plane, selected from the set of planes, intersecting with the position coordinates as the target reference plane; or
rotating the plane, selected from the set of planes, intersecting with the position coordinates, and determining the rotated plane as the target reference plane.

9. The method as claimed in claim 1, wherein the position coordinates are located on the target reference plane, or reference coordinate points determined according to the position coordinates are located on the target reference plane.

10. The method as claimed in claim 1, wherein acquiring position coordinates, in the three-dimensional scene, of the target object to be moved comprises:
acquiring an anchor point of the target object in the three-dimensional scene; and
determining coordinates of the anchor point as the position coordinates.

11. The method as claimed in claim 1, wherein after determining the target reference plane in the three-dimensional scene based on the first sliding operation and the position coordinates, the method further comprises:
updating a default reference plane in the three-dimensional scene as the target reference plane, wherein the default reference plane is a reference plane where the target object is located when the target object moves, before determining the target reference plane based on the first sliding operation and the position coordinates.

12. The method as claimed in claim 1, wherein after controlling, according to the second sliding operation, the target object to stop movement on the target reference plane, the method further comprises:
hiding the target reference plane in the graphical user interface.

13. (canceled)

14. A non-transitory storage medium, the non-transitory storage medium storing a computer program, wherein when the computer program is run by a processor, a device where the non-transitory storage medium is located is controlled to perform the following steps:
acquiring position coordinates, in a three-dimensional scene, of a target object to be moved;
in response to a first sliding operation acting on a graphical user interface, determining a target reference plane in the three-dimensional scene based on the first sliding operation and the position coordinates; and
in response to a second sliding operation on the target object, controlling the target object to move on the target reference plane.

15. An electronic device, comprising a memory and a processor, wherein the memory stores a computer program, and the processor is configured to run the computer program to perform the following steps:
acquiring position coordinates, in a three-dimensional scene, of a target object to be moved;
in response to a first sliding operation acting on a graphical user interface, determining a target reference plane in the three-dimensional scene based on the first sliding operation and the position coordinates; and
in response to a second sliding operation on the target object, controlling the target object to move on the target reference plane.

16. The method as claimed in claim 1, wherein the target reference plane is a plane directly facing a virtual camera in the three-dimensional scene.

17. The method as claimed in claim 1, wherein in response to the second sliding operation on the target object and according to the second sliding operation, controlling the target object to move on the target reference plane comprises:
acquiring a projection point of a touch point corresponding to the second sliding operation on the target reference plane;
determining first world coordinates of the projection point in the three-dimensional scene;
determining second world coordinates of the target object in the three-dimensional scene based on the first world coordinates; and
controlling the target object to move on the target reference plane according to the second world coordinates.

18. The method as claimed in claim 2, wherein graphically displaying the target reference plane in the graphical user interface comprises:
displaying the target reference plane around the target object in the three-dimensional scene.

19. The method as claimed in claim 3, wherein constructing the target reference plane based on the target space vector and the position coordinates comprises:
determining a plane, which passes through the target space vector and the position coordinates of the target object, in the three-dimensional scene, as the target reference plane.

20. The method as claimed in claim 5, further comprises:
in a process of the target object moving on the target reference plane, the adjusted viewing angle of the virtual camera is fixed.

21. The method as claimed in claim 9, wherein constructing the target reference plane based on the target space vector and the position coordinates comprises:
determining, from a set of planes in the three-dimensional scene, a plane intersecting with the reference coordinate points as the target reference plane, wherein normal vectors of the set of planes are the target space vector; or
determining a plane, which passes through the target space vector and the reference coordinate points, in the three-dimensional scene, as the target reference plane.
